(19) United States
(12) Patent Application Publication
(10) Pub. No.: US 2011/0255109 A1
(43) Pub. Date: Oct. 20, 2011

(54) IMAGE FORMING APPARATUS AND CALIBRATION METHOD FOR IMAGE FORMING APPARATUS

(75) Inventor: Keiko Kanamori, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/173,126

(22) Filed: Jun. 30, 2011

Related U.S. Application Data
(62) Division of application No. 12/857,182, filed on Aug. 16, 2010.
(60) Provisional application No. 61/235,174, filed on Aug. 19, 2009.

(51) Int. Cl. G06F 15/00

(52) U.S. Cl. 358/1.12

(57) ABSTRACT

According to an embodiment, in an image forming apparatus and a displaying method for an image forming apparatus, whether a paper is housed in a paper cassette or not is determined, and when it is determined that no paper is housed, a display to instruct manual paper feed is shown on a control panel.

### CROSS-REFERENCE TO RELATED APPLICATIONS

This application is a Division of application Ser. No. 12/857,182 filed on Aug. 16, 2010, the entire contents of which are incorporated herein by reference.

This application is based upon and claims benefit of priority from U.S. Provisional Application No. 61/235174 filed on Aug. 19, 2009, the entire contents of which are incorporated herein by reference.

### FIELD

Embodiments described herein relate generally to an image forming apparatus having a control panel, a paper cassette and a manual insertion tray, thus enabling correct execution of print, and a displaying method for the image forming apparatus.

### BACKGROUND

Recently, a multi-function image forming apparatus having a color copy function, a scan function, a print function and the like is popularly used. In this image forming apparatus, recycled paper, plural types of thick paper, and special papers such as waterproof paper and coated paper can be used in addition to normal paper that is broadly used.

### BRIEF DESCRIPTION OF THE DRAWINGS

FIG. 1 is a perspective view of an image forming apparatus for explaining an embodiment.

FIG. 2 is a block diagram showing the embodiment. FIG. 3 is a view of screen configuration for explaining an operation according to the embodiment.

FIG. 4 is a view of screen configuration for explaining an operation according to the embodiment.

FIG. 5 is a view of screen configuration for explaining an operation according to the embodiment.

FIG. 6 is a view of screen configuration for explaining an operation according to the embodiment.

FIG. 7 is a view of screen configuration for explaining an operation according to the embodiment.

FIG. 8 is a view of screen configuration for explaining an operation according to the embodiment. FIG. 9 is a block diagram showing another embodiment.

### DETAILED DESCRIPTION

In executing the printing, a type of paper as a printing target needs to be selected. However, there is a problem that it is difficult to know which cassette of plural cassettes houses a paper that is used at the time of actually printing.

According to an embodiment, an image forming apparatus comprising: a control panel on which operation and setting is carried out; a paper cassette which houses a paper; a manual insertion tray with which a paper is manually inserted;
a paper presence determination unit which determines whether the designated paper is housed in the paper cassette or not; and a processing unit which displays a result of the determination by the paper presence determination unit and an operation and setting content that should be carried out in accordance with the result of the determination, on the control panel.

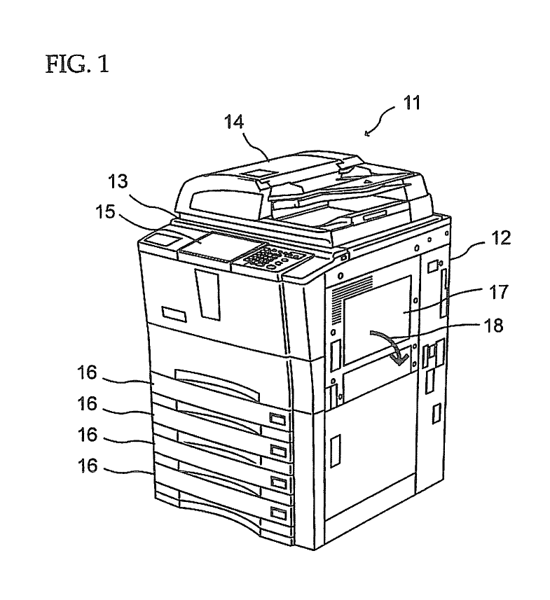

An embodiment will be described hereinafter with reference to the drawings. In the following description of the embodiment, a digital color multi-function peripheral 11 shown in FIG. 1 is described as an example of an image forming apparatus. The digital color multi-function peripheral 11 has a color copy function, a scan function, a print function, a facsimile function and the like.

The digital color multi-function peripheral 11 has a document table 13 in an upper part of a body 12. An automatic document feeder 14 is provided above the document table 13 in such a manner that the automatic document feeder 14 can freely open and close. A control panel 15 is provided on the front side of the same position as the document table 13 in the body 12. Plural paper feed cassettes 16 for housing various papers are provided in a lower part of the body 12.

A manual insertion tray 17 is provided on one lateral side of the body 12 . The manual insertion tray 17 is folded along the lateral side of the machine body as shown in FIG. 1 when there is no need to manually insert a paper into the machine body. The manual insertion tray 17 is configured to unfold in the direction of an arrow 18 in FIG. 1 and thus enable a paper to be placed on the tray when manual insertion of a paper is necessary.

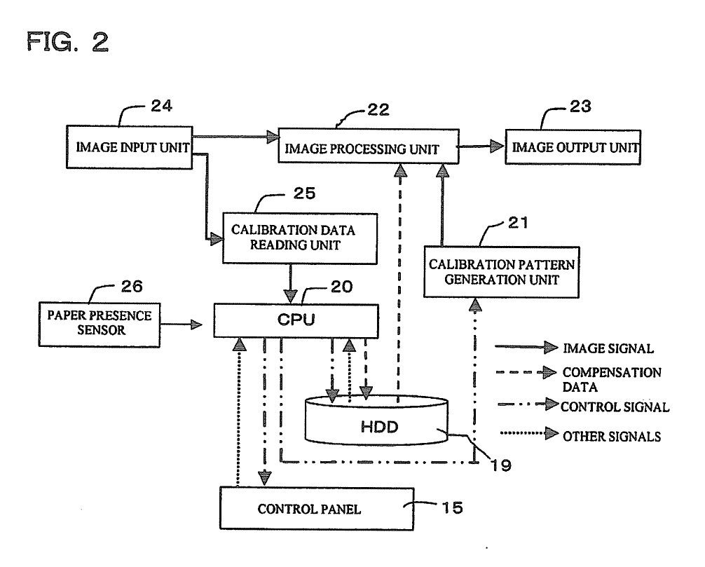

Hereinafter, the embodiment will be described more specifically. FIG. 2 is a block diagram showing the specific configuration according to the embodiment. That is, in FIG. 2, the solid-line arrow represents an image signal. The broken-line arrow represents compensation data. The double-dotted chain-line arrow represents a control signal. The dotted line arrow represents other signals. Compensation data for various papers are stored in a hard disk drive (HDD) 19 as a compensation data table.

In the case of executing calibration for each paper, which will be described in detail later, a signal to designate the execution of calibration and a paper for which the calibration is to be executed is inputted to a CPU 20 from the control panel 15, also shown in FIG. 1. As a calibration execution instruction, first, a target function to be calibrated is designated. For example, when a copy function and a printer function are set in the multi-function peripheral body, which function is to be calibrated is designated.

The CPU 20 instructs a calibration pattern generation unit 21 to generate a calibration pattern. The pattern from the calibration pattern generation unit 21 is inputted to an image processing unit 22. The pattern signal processed by the image processing unit 22 is outputted onto a designated paper by an image output unit 23.

The paper on which the outputted pattern is printed is inputted to an image input unit 24. Necessary data is read from the inputted calibration image by a calibration data reading unit 25. Normally, a scanner is used as the image input unit 24. The data read by the calibration data reading unit 25 is compared with the compensation data in the compensation data table stored in the HDD 19. Thus, compensation data is created so that an optimum image to the designated paper can be formed. The created data is stored in the HDD 19 and used as compensation data at the time of image output onto a subsequently compensated sheet.

The type of a paper as a calibration execution target is thus designated at the time of outputting an image. However, various papers are housed in the plural paper feed cassettes, as shown in FIG. 1. As shown in FIG. 2, a paper presence sensor 26 is installed which, when a paper as a calibration execution target is designated from the control panel 15, detects whether a paper is housed in a paper feed cassette in which the designated paper must be housed.

The paper presence sensor 26 is a sensor which detects whether there is a paper in each paper feed cassette or not. For example, a light-transmitting detection sensor may be installed in each paper feed cassette and the presence or absence of papers in the paper feed cassette may be detected. In this embodiment, the paper presence sensor 26 has the function of detecting whether there is a paper in a designated paper feed cassette or not. That is, a paper type that should be housed is defined for each of the plural paper feed cassettes. It is assumed that, normally, the user places a designated correct paper in each paper feed cassette.

When the execution of calibration and a target paper are designated, the paper presence sensor 26 detects whether there is a paper in the designated paper feed cassette or not. The result of the paper presence detection is visually displayed on the control panel 15 and the operator is notified whether there is a paper in the target paper feed cassette or not.

When there is a paper in the target paper feed cassette, information that calibration continues is displayed on the control panel 15. When there is no paper in the target paper feed cassette, information that there is no paper in the target paper feed cassette is displayed on the control panel 15, and an instruction to insert a target sheet into the machine body by another measure is given on the control panel 15. For example, an instruction to insert a designated paper from the manual insertion tray 17 shown in FIG. 1 is displayed on the control panel 15.

Next, the operation in the embodiment, particularly the operation of the control panel 15, will be described in detail with reference to FIG. 3 to FIG. 8. On the control panel 15 shown in FIG. 3 to FIG. 8, essential parts representing an adjustment function, of various functions, are shown for the explanation of the embodiment.

FIG. 3 shows a screen to designate a target function to be calibrated, and in this example, a screen to select either the copy function or the printer function. The operator can select the function to be calibrated by touch-pressing the corresponding button. FIG. 3 shows that the copy function is selected, as indicated by double slant lines.

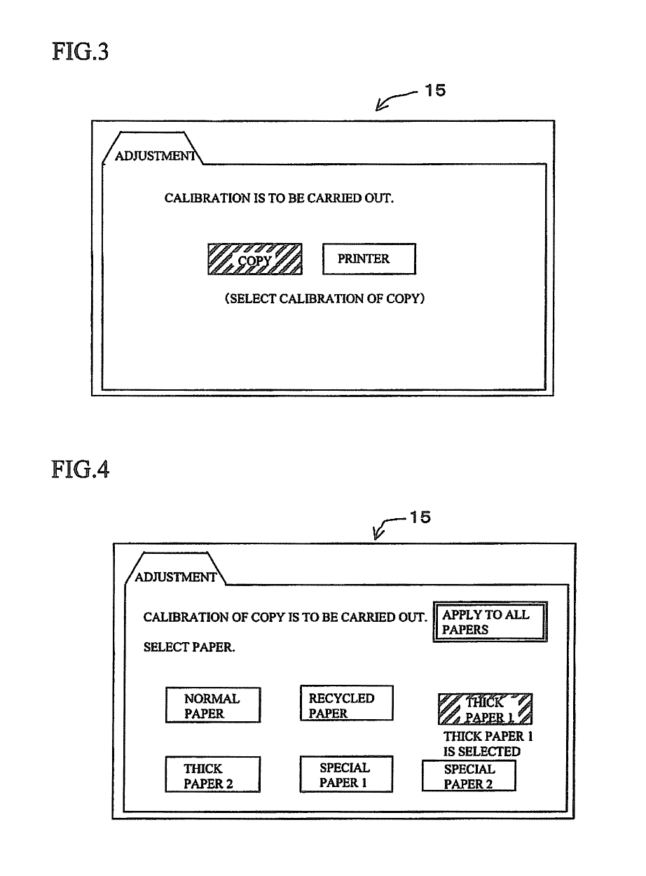

When the selection of the target in FIG. 3 is finished, the screen on the control panel 15 changes to a screen to select a paper for which calibration is to be executed, as shown in FIG. 4. Here, as selection targets, there are seven categories, that is, normal paper, recycled paper, thick paper 1, thick paper 2, special paper 1, special paper 2, and application to all papers, as shown in FIG. 4. FIG. 4 shows that thick paper 1 indicated by double slant lines is selected by the operator.

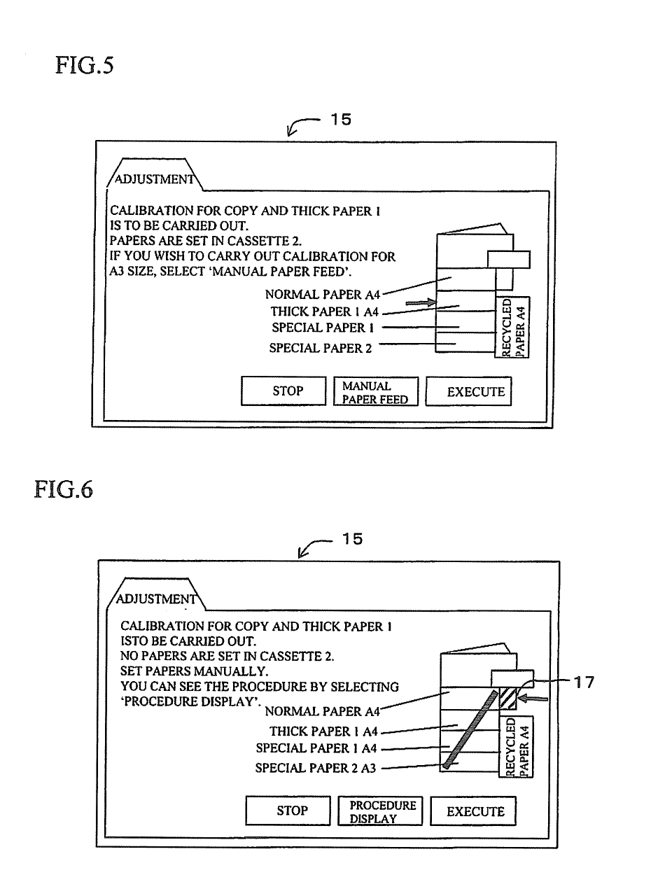

When the selection of the paper is finished, “Calibration for copy and thick paper 1 is to be carried out. Papers are set in cassette 2. If you wish to carry out calibration for A3 size, select ‘manual paper insertion’.” is displayed on the control panel 15, as shown in FIG. 5. At the same time, a configuration view of the machine body, particularly around the paper feed cassettes, is shown.

Then, an arrow pointing the paper feed cassette of thick paper 1, which is selected this time, is displayed. In the paper selection screen of FIG. 4, only the paper type of thick paper 1 is displayed. However, since papers of A4 size are constantly housed, “thick paper 1 A4” is shown in the view of the cassette configuration shown in FIG. 5. Moreover, when the operator still wants thick paper 1 but wants the paper size of A3 instead of A4, an indication of manual paper feed is shown on the display screen in this case.

In the display shown in FIG. 5, “Papers are set in cassette 2” is displayed. This display is based on the result of detection by the paper presence sensor 26 described with reference to FIG. 2. That is, this display shows that the presence of papers in cassette 2 is detected by the paper presence sensor 26. Meanwhile, in FIG. 5, three buttons “stop”, “procedure display” and “execute” are displayed in the bottom of the screen. Thus, with the display shown in FIG. 5, the operator can easily confirm the result of executed procedures visually from the description with letters and characters, the view of essential parts of the machine body, and the arrow indicating the selected cassette.

FIG. 5 shows an example where there are papers in the designated cassette. However, FIG. 6 shows that designated papers are not in placed in a predetermined cassette, as can be seen in the description “Calibration for copy and thick paper 1 is to be carried out . No sheets are set in cassette 2. Set sheets manually.” Consequently, there is a description to instruct that designated papers should be manually inserted. In the view of the machine body shown in FIG. 6, a bold slant line is shown on the part of the paper feed cassettes, highlighting that there is no sheet in the designated cassette. At the same time, an arrow instructs that designated papers should be manually inserted, using the manual insertion tray 17 shown in FIG. 1. In FIG. 6, a “procedure display” button is provided in addition to “stop” and “execute” at the bottom of the screen, and the description shows “(You can see the procedure by selecting ‘procedure display.’)” In the example shown in FIG. 6, as it is detected by the paper presence sensor 26 shown in FIG. 2 that there is no paper in cassette 2 though thick paper 1 is selected, the result that there is no paper is shown to the operator and an instruction and suggestion to manually feed paper is given in order to continue the execution of calibration.

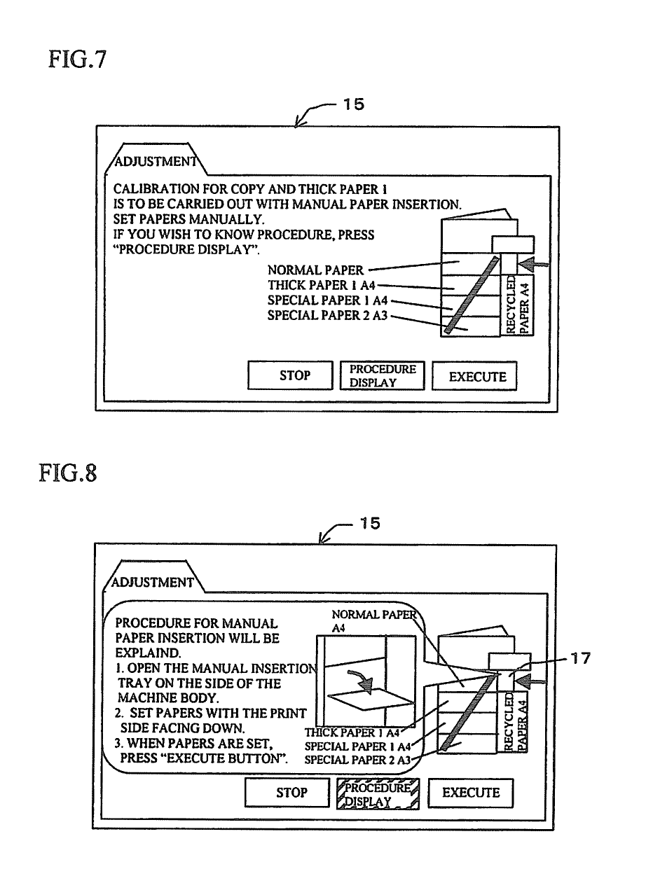

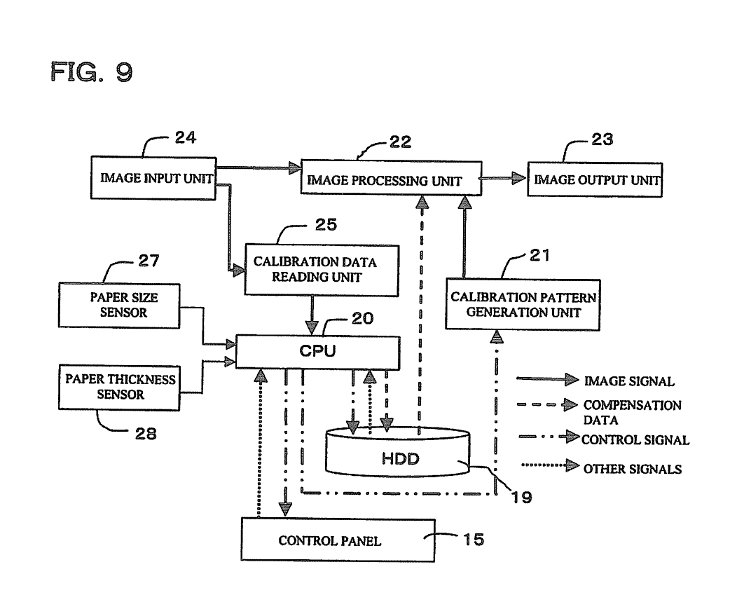

FIG. 7 shows a display to instruct on manual paper feed, as can be seen in the description. FIG. 8 shows a display screen where procedure displaying button at the bottom of the screen of FIG. 7 is pressed when the operator does not know the procedure for manual paper feed. As shown in FIG. 8, the selected “procedure display” button is shaded by double slant lines and the procedure for inserting papers into the machine body from the manual insertion tray 17 are described with an illustration on the screen. Although the illustration of FIG. 8 is schematically shown, it is also possible to show and explain the manual insertion tray of the actual machine more accurately. The explanation of the procedure is itemized as shown in FIG. 8, such as “1. Open the tray. 2. Set papers with the print side facing down. 3. Press the execution button.” The illustration shows an important operation in this procedure, that is, opening the manual insertion tray 17 to the front.

As described above, in this embodiment, the work procedure that is necessary for the execution of printing is explained to the operator with an illustration as well as a description with letters and characters, so that the procedure can easily be executed properly and without requiring the operator's expertise. Thus, convenience for the operator is improved.

In the above embodiment, the example is described in which the paper presence sensor 26 detects whether there is a paper in a designated sheet cassette or not, as shown in FIG. 2, and an instruction to manually feed paper can be given in accordance with the result of the detection.

FIG. 9 shows an example as another embodiment in which a paper size sensor 27 and a paper thickness sensor 28 are used to detect the presence or absence of papers, as a unit which detects whether there are papers in a cassette or not. The paper size sensor 27 has, for example, light-transmitting sensors installed at plural positions which detect the size of papers housed in a paper feed cassette, and thus can detect the size of the housed papers.

Thus, for example, the size of the housed papers can be detected. When A3-size papers are housed while the housed papers should be, for example, A4-size papers, the result of detecting whether there are papers or not is the same for papers of either size. However, when A3-size papers are erroneously housed in the actual cassette despite the operator's designation of printing for A4-size papers, the difference in paper size can be pointed out and displayed, though not shown, as in the displays on the control panel shown in FIG. 3 to FIG. 8. Thus, it is possible to give an instruction to manually feed paper or point out the pressing of the wrong paper designation button.

Moreover, the paper thickness sensor 28 is provided. Thus, when there is thick paper in the actual cassette despite the operator's selection of normal paper, information to this effect is displayed on the control panel as in the foregoing example. Thus, the fact that the papers in the cassette are different from designated papers and an alternative measure to enable continued execution of printing can be indicated or suggested. The paper thickness sensor can detect the thickness by detecting the difference in transmitted light or by measuring the pressure when a paper passes between rollers.

In the example of FIG. 9, both the paper size sensor 27 and the paper thickness sensor 28 are installed. However, depending on the type of papers housed in the plural paper feed cassettes, one of these sensors can suffice or both sensors can be installed.

Moreover, though not shown, a sensor which detects the degree of gloss or roughness of the paper surface can be installed as a sensor to detect the presence of papers and identify the type of papers. In detecting the degree of gloss or roughness of the paper surface, reflected light can be used and characteristics of reflected light proper to each paper can be used for detection.

While certain embodiments have been described, these embodiments have been presented by way of example only, and are not intended to limit the scope of the inventions. Indeed, the novel apparatuses and methods described herein may be embodied in a variety of other forms: furthermore, various omissions, substitutions and changes in the form of the apparatuses described herein may be made without departing from the spirit of the inventions. The accompanying claims and their equivalents are intended to cover such forms or modifications as would fall within the scope and spirit of the inventions.

What is claimed is:

1. An image forming apparatus comprising:
a control panel on which operation and setting is carried out;
a paper cassette which houses a paper;
a manual insertion tray with which a paper is manually inserted;
a paper presence determination unit which determines whether the designated paper is housed in the paper cassette or not; and
a processing unit which displays a result of the determination by the paper presence determination unit and an operation and setting content that should be carried out in accordance with the result of the determination, on the control panel.

2. The apparatus of claim 1, wherein the paper presence determination unit determines whether a paper is housed in the paper cassette or not, and when it is determined that a paper is housed, the paper presence determination unit determines that a paper of a type that is preset in the cassette is housed.

3. The apparatus of claim 1, wherein the paper presence determination unit detects a size of a paper housed in the paper cassette and thereby determines that a paper is housed in the paper cassette, and the paper presence determination unit determines presence or absence of a paper according to whether or not the paper size coincides with a paper of a type that is preset in the paper cassette.

4. The apparatus of claim 1, wherein the paper presence determination unit detects a thickness of a paper housed in the paper cassette and thereby determines that a paper is housed in the paper cassette, and the paper presence determination unit determines presence or absence of a paper according to whether or not the thickness of the paper coincides with a paper of a type that is preset in the paper cassette.

5. The apparatus of claim 1, wherein when it is determined by the paper presence determination unit that no paper is housed in the paper cassette, the processing unit carries out display on the control panel to give an instruction to insert a paper from the manual insertion tray.

6. The apparatus of claim 2, wherein when it is determined by the paper presence determination unit that no paper is housed in the paper cassette, the processing unit carries out display on the control panel to give an instruction to insert a paper from the manual insertion tray.

7. The apparatus of claim 3, wherein when it is determined by the paper presence determination unit that no paper is housed in the paper cassette, the processing unit carries out display on the control panel to give an instruction to insert a paper from the manual insertion tray.

8. The apparatus of claim 4, wherein when it is determined by the paper presence determination unit that no paper is housed in the paper cassette, the processing unit carries out display on the control panel to give an instruction to insert a paper from the manual insertion tray.

9. The apparatus of claim 1, wherein the paper cassette is designated to house different types of papers.

10. The apparatus of claim 2, wherein the paper cassette is designated to house different types of papers.

11. The apparatus of claim 3, wherein the paper cassette is designated to house different types of papers.

12. The apparatus of claim 4, wherein the paper cassette is designated to house different types of papers from each other.

13. The apparatus of claim 9, wherein a unit which displays a paper as a target of printing by selecting a button from buttons showing plural different types of papers, a unit which displays an instruction for manual paper insertion when the selected paper is not set in the cassette, a unit which displays a button to give an instruction to display a procedure for manual paper insertion, and a unit which displays an explanation of the manual paper insertion procedure with an illustration.

14. The apparatus of claim 10, wherein the control panel includes a unit which displays a paper as a target of printing by selecting a button from buttons showing plural different types of papers, a unit which displays an instruction for manual paper insertion when the selected paper is not set in the cassette, a unit which displays a button to give an instruction to display a procedure for manual paper insertion, and a unit which displays an explanation of the manual paper insertion procedure ,with an illustration.

15. The apparatus of claim 11, wherein the control panel includes a unit which displays a paper as a target of printing by selecting a button from buttons showing plural different types of papers, a unit which displays an instruction for manual paper insertion when the selected paper is not set in the cassette, a unit which displays a button to give an instruction to display a procedure for manual paper insertion, and a unit which displays an explanation of the manual paper insertion procedure with an illustration.

16. The apparatus of claim 12, wherein the control panel includes a unit which displays a paper as a target of printing by selecting a button from buttons showing plural different types of papers, a unit which displays an instruction for manual paper insertion when the selected paper is not set in the cassette, a unit which displays a button to give an instruction to display a procedure for manual paper insertion, and a unit which displays an explanation of the manual paper insertion procedure with an illustration.

17. A displaying method for an image forming apparatus having a paper cassette which house a paper, the method comprising:
displaying whether a selected paper is housed in the paper cassette or not;
when the paper is not housed in the paper cassette, carrying out display to give an instruction for manual paper insertion and also displaying a manual paper insertion procedure display button; and
when the manual paper insertion procedure display button is selected, displaying a procedure for manual paper insertion.

18. The method of claim 17, wherein the display of the manual paper insertion procedure includes displaying an illustration to for explaining how to carry out manual paper insertion.

19. A displaying method for a image forming apparatus having plural paper cassettes which house different types of papers, the method comprising:
displaying a selection button for each of the plural types of papers;
displaying whether a selected paper is housed in the paper cassette or not;
when the selected paper is not housed in the paper cassette, carrying out display to give an instruction for manual paper insertion and also displaying a manual paper insertion procedure display button; and
when the manual paper insertion procedure display button is selected, displaying a procedure for manual paper insertion.

20. The method of claim 19, wherein the display of the manual paper insertion procedure includes displaying an illustration to for explaining how to carry out manual paper insertion.
